(19) United States
(12) Patent Application Publication
(10) Pub. No.: US 2022/0015403 A1
(43) Pub. Date: Jan. 20, 2022

(54) COMPOSITION FOR IMPROVING FLAVOR OF FOOD, CONTAINING PHLOROTANNIN AS ACTIVE INGREDIENT

(71) Applicant: BOTAMEDI INC., Jeju-si, Jeju-do (KR)

(72) Inventors: Haeng Woo LEE, Bellevue, WA (US); Seong Ho KIM, Daejeon (KR); Hyeon Cheol SHIN, Incheon (KR); Hyun Cheol CHEON, Seoul (KR); Jin Suk YUN, Jeju-si (KR); Moon Seok KANG, Jeju-si (KR)

(73) Assignee: BOTAMEDI INC., Jeju-si, Jeju-do (KR)

(21) Appl. No.: 17/311,006

(22) PCT Filed: Dec. 3, 2019
(86) PCT No.: PCT/KR2019/016914

§ 371 Date: Jun. 4, 2021

(30) Foreign Application Priority Data
Dec. 5, 2018 (KR) 10-2018-0155106

(51) Int. Cl. A23L 27/00; A23L 27/20; A23L 27/30; A23L 27/10; A23L 2/60; A23L 2/56; A23L 29/30; A23L 29/206

(52) U.S. Cl. CPC A23L 27/88; A23L 27/2052; A23L 27/34; A23L 29/206; A23L 2/60; A23L 2/56; A23L 29/37; A23L 27/10

(57) ABSTRACT

The present invention relates to a composition and a product which are used when cooking food containing carbohydrates and proteins as main ingredients, when cooling processed food such as ramen, when preparing vegetable protein food such as tofu, or when administering alcoholic beverages, coffee, tea, beverages and the like, so as to increase the elasticity, texture or taste of prepared or cooked food, thereby improving the flavor thereof.

### FIELD OF INVENTION

The present invention relates to a composition capable of improving flavor of food, and a product including the same.

The present invention relates to a composition and a product, which are used when cooking food materials containing carbohydrates and proteins as main ingredients, when cooking processed food such as ramen, when preparing vegetable protein food such as tofu, or when drinking alcoholic beverages, coffee, tea, carbonated beverages and the like, in order to increase elasticity, texture or taste of the prepared or cooked food, thereby improving flavor of the food. When using the composition and product described above, it is possible to reduce use of salt and artificial additives in food, improve harmony of taste and flavor of the food. Further, in the case of alcoholic beverages, hangover symptoms may be improved. The present invention also relates to a composition and a product for improvement of food flavor, which can improve preservation of cooked food and may contribute to health promotion such as weight control and prevention of metabolic diseases through continuous intake.

### BACKGROUND OF INVENTION

With recent advancement of westernization, food culture has significantly changed compared to the past. The ideal diet may be considered to be one in which fresh ingredients containing nutrients beneficial to the human body produced in nature are cooked for intake while saving (or retaining) most of the original taste thereof. However, due to problems in regard to freshness of the ingredients, additives, artificial seasonings, etc., which are distributed in bulk as advanced urbanization and industrialization, diet and regimens of modern people have strayed too far from ideal conditions. As a result, the taste of food is not a true taste based on fresh ingredients but is dominated by artificial tastes, hence causing a phenomenon of deteriorating the quality of diet. Further, artificial additives, salts, sweeteners, etc. which are added to alter the taste of processed foods, are indiscreetly used, hence becoming a threat to health. Furthermore, lack of exercise, stress, excessive intake of fat and/or sugar, and harmful effects of various food additives, which are commonly used in urban life, have been combined to thus cause very serious deterioration in the diet of modern people.

### SUMMARY OF INVENTION

### Technical Problem to be Solved

Main ingredients of rice, vegetables and meat are water and carbohydrates or protein. In the normal state of raw food (that is, in an uncooked state), these raw materials are not suitable for humans to eat and efficiently digest and absorb in aspects of hygiene, nutrient absorption, and mouth feel or texture (too hard, chewy, etc.). Accordingly, in almost all cases, such raw materials are properly heated or cooked to enable consumption thereof.

In the case of hard rice, heating with addition of water may produce soft rice for intake. Specifically, this process may be described as follows; starch constituting the rice exists originally in a high-density and low-moisture state and, when water and heat are added, a physical form of polymer in the starch is converted into a low-density and high-moisture state and finally becomes a soft state suitable for eating. However, since physical force to maintain the soft state is not large enough, a good edible state is sensitively altered due to some parameters such as an amount of water to be added, a time left after cooking, etc.

In the case of meat comprising protein, raw meat is usually cooked with heat to be safe for consumption. A structure of protein chains transformed by heating, as well as moisture originally contained in the raw state should be distributed together while maintaining an appropriate spacing there between in order to ensure soft texture and retain juices. However, if the meat contains a lot of fat normally distributed therein, the texture tends to become tough or stiff due to excessive dehydration during cooking.

Therefore, even with good food ingredients, the taste of food may be deteriorated during processing or cooking, and may prevent healthy absorption (or ingestion) in the intestine after intake.

Accordingly, it is an object of the present invention to provide a composition that may preserve and reinforce flavor characteristics such as natural textures of food ingredients by incorporating natural molecules suitable for food when processing and cooking food ingredients, and may reduce offensive odor or taste while protecting health from obesity or metabolic diseases.

Another object of the present invention is to provide a composition that may reduce use of typical additives when used in a manufacturing process of tofu, which is a food product using vegetable protein, since there is no difference in taste even if an antifoaming agent or a coagulant is not used or an amount thereof is reduced. Further, the present invention may provide a composition with advantages in that: no significant difference in taste occurs when added during cooking of processed foods such as ramen to reduce use of salt and seasonings; harmony of taste is achieved when applied to alcoholic drinks and beverages; offensive odor and/or taste is reduced; and a burden or difficulty in drinking and hangover during ingestion.

### TECHNICAL SOLUTION

In order to achieve the above objects, the present invention provides a composition for improvement of food flavor, which includes a phlorotannin compound useable as an active ingredient when cooking food, preparing food materials or manufacturing processed food products or before ingestion of processed food.

Further, the present invention provides a product for improvement of food flavor, which includes the above composition for improvement of food flavor.

### Effect of Invention

The compositions and product according to the present invention, which contain phlorotannin as an active ingredient, may be applied to the cooking of foods or ingredients containing carbohydrates and proteins as a main component in order to increase the elasticity of cooked foods and harmonize texture, cooking smell and taste of the food, thereby improving flavor of the food. Further, the composition and product of the present invention may be applied to intake of beverages, alcoholic drinks, etc., in order to attain the harmony of tastes thereof, while reducing offensive odor and/or taste as well as a trouble in drinking and hangover. Further, the composition and product of the present invention may enable the original properties and texture of cooked food to be maintained for a long time even when storing the cooked food. Further, even when applied to meats with low fat content, the texture of the meats may be improved to reduce health risk due to fat intake. Further, when used in the manufacture or cooking of processed foods, the taste of the processed foods is not deteriorated even when using less salt or sweetener additives. Further, if continuously taken by a human, the composition and product of the present invention may contribute to health promotion in relation to obesity or metabolic syndromes.

### BEST MODE

Phlorotannin is an oligomer containing phloroglucinol produced only from brown algae as a monomer and has various structures depending on how many types of monomers are combined. It is well known that phlorotannin is suitable for edible use and has health promoting effects such as antioxidant, antibacterial, anti-obesity, blood circulation improvement, anti-diabetic, anti-hyperlipidemic and anti-inflammatory effects. These phlorotannin molecules have a large number of hydroxyl groups capable of hydrogen bonding with the main ingredients of food such as water, carbohydrates and proteins, whereby a hydrogen bond network composed of food ingredients and water can be greatly expanded and strengthened by adding a small amount of phlorotannin.

Therefore, the present inventors have found that, as a result of testing the phlorotannin composition for various food ingredients, the texture of food may be greatly improved by adding a proper amount of a phlorotannin composition, and preservation and flavor of food ingredients or cooked food may also be improved. In addition, it could also be found that taste is not substantially deteriorated even when decreasing the amount of salt used during cooking, whereby metabolic syndromes such as obesity, blood pressure, hyperlipidemia and hyperglycemia may be improved through continuous intake of cooked food with addition of phlorotannin.

In the case of raw meat, the meat mainly comprises protein and water, and phlorotannin may amplify a hydrogen-bond network between the protein and the water in the meat, thereby moisturizing the meat during cooking (maintaining juicy meat). Such amplification of hydrogen bonds may not only soften the meat but also impart effects of preventing formation of chemical cross-linkages between proteins during cooking, thereby preventing the meat from becoming chewy and maintaining softness as much as possible. Even when cooking rice into steamed rice, the hydrogen bond network may be amplified in a structure formed of starch polymers and water molecules, thereby improving elasticity and shape of the steamed rice. Further, a dehydration rate during storage may be reduced (that is, delayed dehydration). The hydrogen bond network formed and amplified in the meat or steamed rice may reduce exhalation of offensive odor such as fishy smell derived from food ingredients while more diffusing or emitting fat-derived flavor, thereby achieving effects of promoting food flavor.

When the composition of the present invention is applied to foods with lots of water such as soup, stew, hot soup, etc., the exhalation of offensive odor such as fishy smell derived from the food ingredients is reduced by the hydrogen bond network formed and amplified in the same, while fat-derived smell is further spread to achieve effects of enabling the broth (soup) to have fresher and richer flavor. Further, even if the amount of salt, sweetener and/or seasonings used for cooking food to be well seasoned is decreased, the taste of food is not deteriorated.

Meanwhile, in the production of tofu, since surfactants such as lecithin and protein contained in soybeans generate a lot of foam during heating, an additive such as an antifoaming agent must be used for removal of the foam. However, chemical additives may be harmful to the human body, and edible oil used as a substitute for the same has a strong scent, which may mask the savory flavor of tofu itself and thus deteriorate the taste of tofu. When the composition of the present invention is used, interfacial reaction may be stabilized by action of hydroxyl groups and oxygen groups in phlorotannin, thereby relieving the foam.

The food prepared in this way may effectively interrupt bacterial propagation by phlorotannin molecules distributed between the spaces formed by polymer-water in the food ingredients, thereby preventing the food from being easily spoiled or damaged. Further, because of the strengthened hydrogen bond network, force of retaining moisture is increased to thus significantly increase preservation of food.

In this way, when the food cooked while adding phlorotannin is consumed, absorption of components possibly causing metabolic diseases such as sugar, cholesterol and fat may be minimized, in addition, a favorable environment for beneficial intestinal bacteria may be produced, thereby contributing to health promotion.

Hereinafter, the present invention will be described in detail.

The composition for improvement of food flavor according to the present invention may include 20 to 100% by weight (“wt. %”) of a phlorotannin compound. The composition of the present invention including the phlorotannin in the above content may improve the flavor of food.

Phlorotannin is a natural-derived ingredient and may be obtained by any conventional method. For example, this component may be synthesized using commercially available reagents, or may be extracted from natural products, especially seaweed. That is, the composition for improvement of food flavor, which contains the phlorotannin compound as an active ingredient, may include a seaweed extract.

Phlorotannin may be extracted from seaweeds, especially brown algae, more particularly, from one or more selected from the group consisting of Eisenia bicyclis, Ecklonia kurome, Ecklonia cava, Ecklonia stolonifera, Ecklonia maxima and Ecklonia radiata.

The composition of the present invention may additionally contain 0 to 80 wt. % of components consisting of a carbohydrate component such as mannitol, alginic acid, fucoidan, laminarin, etc., and a lipid component such as fucosterol, fucoxanthin, etc., in addition to phlorotannin.

The composition for improvement of food flavor according to the present invention may include at least one phlorotannin selected from compounds represented by following Formulae 1 to 12 as an active ingredient.

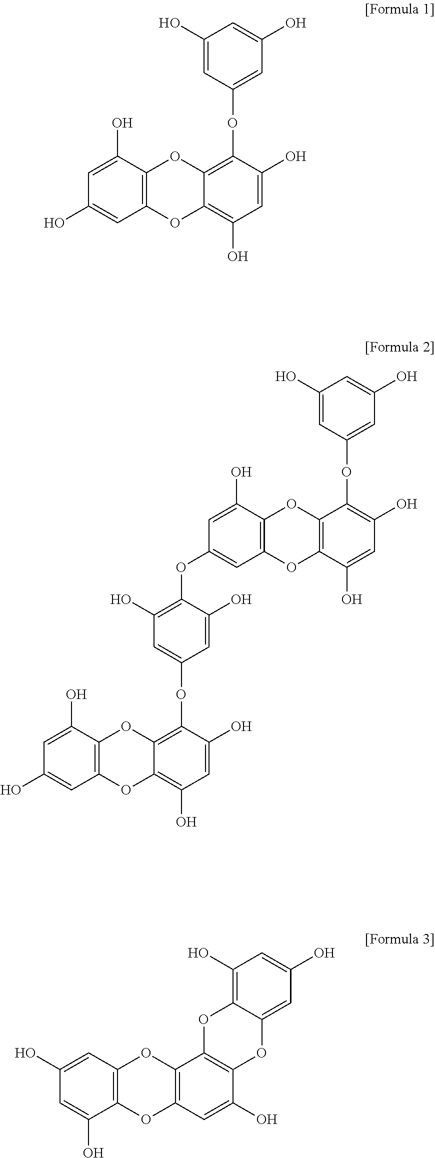 [SMILES: Oc1cc(O)cc(Oc2c(O)cc(O)c3c2Oc2c(O)cc(O)cc2O3)c1 ; Oc1cc(O)cc(Oc2c(O)cc(O)c3c2Oc2c(O)cc(Oc4c(O)cc(Oc5c(O)cc(O)c6c5Oc5c(O)cc(O)cc5O6)cc4O)cc2O3)c1 ; Oc1cc(O)c2oc3cc(O)c4oc5cc(O)cc(O)c5oc4c3oc2c1]

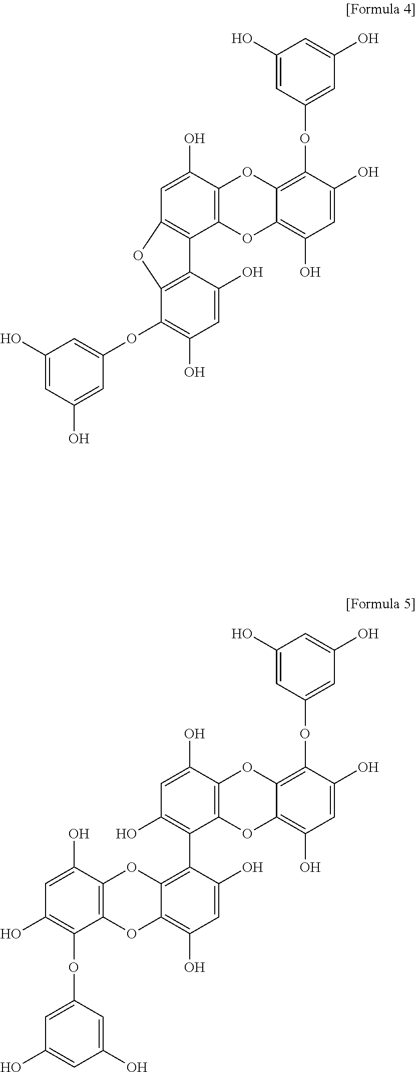 [SMILES: Oc1cc(O)cc(Oc2c(O)cc(O)c3c2Oc2c(O)cc4oc5c(Oc6cc(O)cc(O)c6)c(O)cc(O)c5c4c2O3)c1 ; Oc1cc(O)cc(Oc2c(O)cc(O)c3c2Oc2c(O)cc(O)c(-c4c(O)cc(O)c5c4Oc4c(O)cc(O)c(Oc6cc(O)cc(O)c6)c4O5)c2O3)c1]

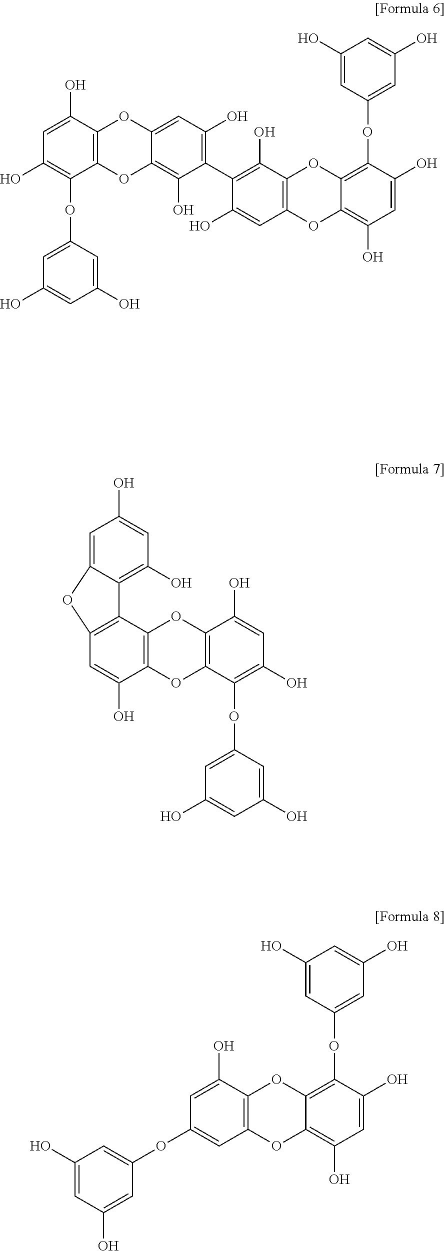 [SMILES: Oc1cc(O)cc(Oc2c(O)cc(O)c3c2Oc2c(cc(O)c(-c4c(O)cc5c(c4O)Oc4c(Oc6cc(O)cc(O)c6)c(O)cc(O)c4O5)c2O)O3)c1 ; Oc1cc(O)cc(Oc2c(O)cc(O)c3c2Oc2c(O)cc4oc5cc(O)cc(O)c5c4c2O3)c1 ; Oc1cc(O)cc(Oc2cc(O)c3c(c2)Oc2c(O)cc(O)c(Oc4cc(O)cc(O)c4)c2O3)c1]

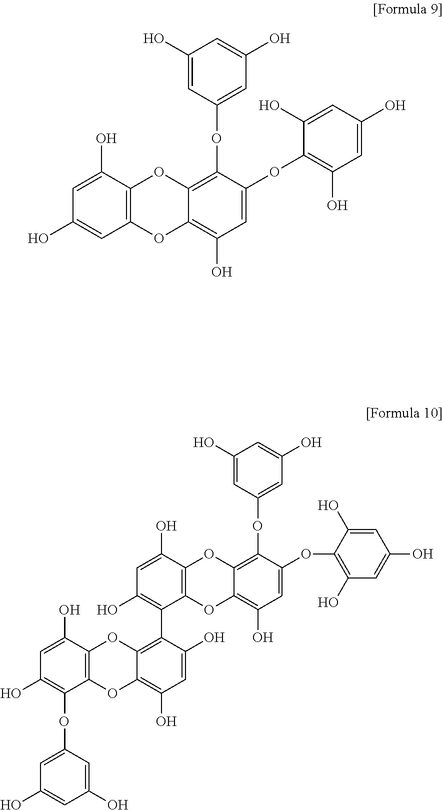 [SMILES: Oc1cc(O)cc(Oc2c(Oc3c(O)cc(O)cc3O)cc(O)c3c2Oc2c(O)cc(O)cc2O3)c1 ; Oc1cc(O)cc(Oc2c(O)cc(O)c3c2Oc2c(O)cc(O)c(-c4c(O)cc(O)c5c4Oc4c(O)cc(Oc6c(O)cc(O)cc6O)c(Oc6cc(O)cc(O)c6)c4O5)c2O3)c1]

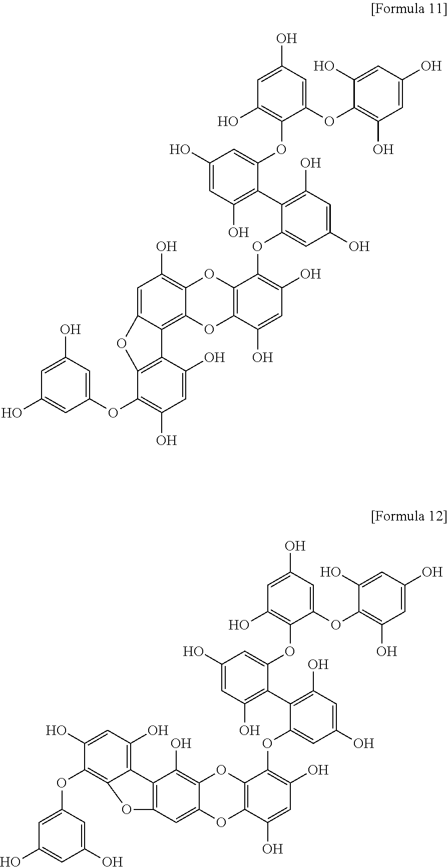 [SMILES: Oc1cc(O)cc(Oc2c(O)cc(O)c3c2oc2cc(O)c4c(c23)Oc2c(O)cc(O)c(Oc3cc(O)cc(O)c3-c3c(O)cc(O)cc3Oc3c(O)cc(O)cc3Oc3c(O)cc(O)cc3O)c2O4)c1 ; Oc1cc(O)cc(Oc2c(O)cc(O)c3c2oc2cc4c(c(O)c23)Oc2c(c(O)cc(O)c2Oc2cc(O)cc(O)c2-c2c(O)cc(O)cc2Oc2c(O)cc(O)cc2Oc2c(O)cc(O)cc2O)O4)c1]

The composition for improvement of food flavor according to the present invention may include at least one phlorotannin selected from a variety of phlorotannins represented by Formulae 2, 4, 5 and 8, as an active ingredient.

The composition for improvement of food flavor according to the present invention may include two or morephlorotannins selected from a variety of phlorotannins represented by Formulae 2, 4, 5 and 8, as an active ingredient.

The composition for improvement of food flavor according to the present invention may include 1 to 65 wt. % of phlorotannin of Formula 2 and 0.3 to 45 wt. % of phlorotannin of Formula 4 to a total weight of the composition. Using the composition containing phlorotannin of Formula 2 andphlorotannin of Formula 4 in the above contents in the food may improve the flavor of food.

The composition for improvement of food flavor according to the present invention may include 1 to 45 wt. % of phlorotannin of Formula 5 and 0.3 to 45 wt. % of phlorotannin of Formula 8 to a total weight of the composition. Using the composition containing phlorotannin of Formula 5 and phlorotannin of Formula 8 in the above contents in the food may improve the flavor of food such as texture, scent and taste of food.

The composition for improvement of food flavor according to the present invention may include 1 to 60 wt. % of phlorotannin of Formula 2, 0.3 to 20 wt. % of phlorotannin of Formula 4, 0.1 to 10 wt. % of phlorotannin of Formula 5, and 0.1 to 5 wt. % of phlorotannin of Formula 8. Using the composition containing all of phlorotannins of Formulae 2, 4, 5 and 8 in the above contents, respectively, may specially improve the flavor of food.

The composition for improvement of food flavor according to the present invention may include: 0.1 to 3 wt. % of phlorotannin of Formula 1; 5 to 21 wt. % of phlorotannin of Formula 2; 1 to 3 wt. % of phlorotannin of Formula 3; 0.5 to 5 wt. % of phlorotannin of Formula 4; 0.1 to wt. % of phlorotannin of Formula 5; 0.5 to 8 wt. % of phlorotannin of Formula 6; 0.1 to 1 wt. % of phlorotannin of Formula 7; 0.1 to 8 wt. % of phlorotannin of Formula 8; 0.1 to wt. % of phlorotannin of Formula 9; 0.1 to 7 wt. % of phlorotannin of Formula 10, 0.1 to 3 wt. % of phlorotannin of Formula 11; and 0.1 to 4 wt. % of phlorotannin of Formula 12.

The composition for improvement of food flavor according to the present invention may include 20 to 100 wt. % of phlorotannin, 0 to 30 wt. % of mannitol, 0 to 25 wt. % of alginic acid, 0 to 25 wt. % of fucoidan, 0 to 10 wt. % of fucosterol, 0 to 10 wt. % of fucoxanthin and 0 to 10 wt. % of laminarin. When the composition of the present invention including the above components in the above contents is used in food, the flavor of food may be particularly improved and preservation of food may also be enhanced.

The composition for improvement of food flavor according to the present invention may include 20 to 97 wt. % of phlorotannin, 1 to 30 wt. % of mannitol, 1 to 25 wt. % of alginic acid, 0.5 to 25 wt. % of fucoidan, 0.1 to 10 wt. % offucosterol, 0.1 to 10 wt. % of fucoxanthin and 0.1 to 10 wt. % of laminarin. The composition of the present invention may particularly improve the flavor of food when the composition including the above components in the above contents is used in the food.

The present invention may provide a composition for improvement of food flavor, which can improve at least one of meat juice, chewy taste, soft taste and scent when the composition is used to cook protein-based food ingredients.

The present invention may provide a composition for improvement of food flavor, which can improve at least one of chewy taste, soft taste and scent when the composition is used to cook carbohydrate-based food ingredients.

The present invention may provide a composition for improvement of food flavor, which can improve preservation of the texture and scent of food ingredients or cooked food.

The present invention may provide a composition for improvement of food flavor, which can additionally contribute to health promotion through ingestion of cooked food and, in particular, contribute to health promotion such as reduction in blood pressure, blood sugar, cholesterol and obesity.

The present invention may provide use of a phlorotannin compound for improvement of food flavor.

The present invention may provide a food flavor improving product that includes the composition for improvement of food flavor described above.

The present invention may provide a food flavor improving product, which includes a phlorotannin compound as an active ingredient.

The present invention may provide a flood flavor improvement seasoning, which includes a phlorotannin compound as an active ingredient.

The food flavor improving product of the present invention may be in the form of powder, paste, block, liquid, or the like.

The food flavor improving product of the present invention may be in the form of a sprayer or a drop ejection container when manufactured in liquid form.

The phlorotannin composition in the food flavor improving product may be included in a content of 0.1 to 100 wt. %, preferably 0.2 t 50 wt. % and, more preferably 1 to 30 wt. % to a total weight of the product. If the phlorotannin composition is contained in the above amounts, flavor improving effects are excellent, and effects of improving the texture of food as well as flavor preservation are also excellent.

The food flavor improving product of the present invention may include various natural food materials, various binders, additives, emulsifiers, thickeners, anti-blocking agents, drying agents, water, edible oils, etc. which are useable in food to impart a shape of the product.

The food flavor improving product of the present invention may include: 0.1 to 100 wt. % of a phlorotannin composition; 0 to 99.9 wt. % of at least one selected from polymers and dietary fibers derived from carbohydrates that are useable in food production; and 0 to 99.9 wt. % of purified water.

The food flavor improving product of the present invention may include: 0.2 to 50 wt. % of a phlorotannin composition; 0 to 99.8 wt. % of at least one selected from polymers and dietary fibers derived from carbohydrates that are useable in food production; and 50 to 99.8 wt. % of purified water. When the food flavor improving product contains a polymer derived from carbohydrates as well as phlorotanninin the above contents, effects of improving the flavor of food are excellent, stability of the phlorotannin composition and in vivo absorption become better, and preservation of the food to which the composition is applied may be improved.

The polymer may include, for example, dextrin, maltodextrin, pectin, xan than gum, cellulose or dietary fiber.

The dietary fiber may be oligosaccharide or inulin.

The food flavor improving product of the present invention may be in the form of powder, liquid-spray and paste in combination with dextrin.

The composition or product for improvement of food flavor according to the present invention may be applied to the cooking of carbohydrate-containing foods, the cooking of protein-containing foods, tofu production, intake of liquid products such as drinking water, coffee, tea, carbonated beverages, alcoholic drinks, etc.

The composition or product for improvement of food flavor according to the present invention may be introduced during cooking of foods in the home or restaurant in order to substitute or supplement the functions of chemical additives and/or salt.

Further, the composition or product for improvement of food flavor according to the present invention may be added during the manufacturing process of processed foods such as tofu in order to replace or supplement the functions of chemical additives and/or salt. When tofu is prepared using the composition or product for improvement of food flavor according to the present invention, one or more functions among reduction of salt use, no use of antifoaming agent, improvement in taste, flavor and texture, etc. may be improved.

The composition or product for improvement of food flavor according to the present invention may be used for cooking rice, noodles, meat and/or seasoned vegetables.

An example of the food to which the composition or product for improvement of food flavor according to the present invention is applicable may be the food containing protein as a main component. When meats such as beef, pork, chicken, lamb, etc., as well as fish, shellfish, crustaceans, etc., which are food ingredients containing mainly protein, are cooked along with the composition or product for improving food flavor according to the present invention, one or more of juicy, chewy, soft, sweet, salty, sour and bitter tastes and scent may be improved.

An example of the food to which the composition or product for improvement of food flavor according to the present invention is applicable may be the food containing carbohydratesas a main component. When grains such as rice, wheat, corn, sweet potato, starch, etc., as well as vegetables, which are food ingredients containing mainly carbohydrates, are cooked along with the composition or product for improving food flavor according to the present invention, one or more of chewy, soft, savory, sweet, salty, sour and bitter tastes and scent may be improved.

In the case of noodles cooked using the food flavor improving product of the present invention, improvement was exhibited in terms of chewy and smooth features, while bean sprouts showed crunchy texture and improved shelf life.

When raw state of oysters and sashimi to which the food flavor improving product of the present invention was applied, respectively, as well as the same foods without application of the product of the present invention were left at room temperature for about 1 hour, the foods without application of the product of the present invention were significantly altered in terms of physical properties and color whereas the foods with application of the product of the present invention were found to maintain original states.

It was found that the cooked rice using the food flavor improving product of the present invention is greatly improved in terms of storage at room temperature, refrigeration storage, freezing storage, maintenance of state immediately after cooking, etc.

When the food is cooked along with the food flavor improving product of the present invention, not only the chewy taste of the food but also offensive odor or taste possibly appearing after cooking the food are reduced and overall flavor may be improved.

The composition or product for improvement of food flavor according to the present invention may be added to favorite foods such as coffee, tea and liquor in order to improve one or more of sweetness, sourness, bitterness, flavor, soft taste, richness, throat smoothness and hangover.

### DETAILED DESCRIPTION OF PREFERRED EMBODIMENTS OF INVENTION

Hereinafter, the present invention will be described in more detail through examples. However, the following examples are intended to illustrate the present invention more specifically, but the scope of the present invention is not limited by the following examples. The following examples may be appropriately modified and changed by those skilled in the art within the scope of the present invention.

### Example 1—Preparation of Composition Containing Phlorotannin

In order to prepare a composition containing phlorotannin according to the present invention as an active ingredient, phlorotannin was extracted from domestic brown algae by the following method.

Ecklonia cava was washed with distilled water to remove foreign substances, dried in the shade, and then crushed. 500 g of Ecklonia cava was placed in an extraction container, 30 wt. % of alcohol solution was added thereto, which was an amount equal to 20 times the weight of Ecklonia cava, followed by reflux-extraction at 75 to 80° C. for 4 hours to obtain an extract. The extract was filtered through a 10 μm filter screen, and the filtered extract was concentrated under reduced pressure to obtain a primary extract concentrate. The primary extract concentrate was dried in a vacuum dryer and pulverized to obtain 170 g of composition 1.

After dissolving the composition 1 in hot water at 50° C., the solution was adsorbed on an adsorption resin, washed with water and eluted with alcohol, thereby yielding phlorotannin eluate. The eluate was filtered through a 1 μm filter screen, and the filtered extract was concentrated under reduced pressure to obtain a second extract concentrate. The second extract concentrate was dried in a vacuum dryer, and then pulverized to obtain 30 g of composition 2.

Thereafter, the composition 2 was suspended in 20-fold amount of distilled water, and extracted 3 times with the same amount of ethyl acetate solvent in order to obtain an ethyl acetate fraction. The ethyl acetate fraction was concentrated under reduced pressure, and the concentrated solution was dried in a vacuum dryer, and then pulverized to obtain 10 g of Composition 3.

The composition 3 was dissolved in 30% methanol, followed by separating the same into compositions 4 and 5 through reverse phase chromatography. The separation was conducted using a 15 to 80% methanol solution. Further, the solution separated using a 15 to 30% methanol solution was concentrated to obtain 42 g of composition. Further, the solution separated in a 30 to 80% methanol solution was concentrated to obtain 57 g of composition.

Each of compositions 1 to 5 obtained above was loaded into a liquid chromatograph, followed by separation of compounds. Herein, the obtained compounds were identified as compounds of Formula 1 to Formula 12 by a compound structure analysis instrument (NMR). For each of the compositions 1 to 5 prepared as described above, the composition was dissolved in 60% methanol, filtered through a 0.2 μm membrane filterpaper and then loaded into a high-speed liquid chromatograph. In the high-speed liquid chromatograph using an HP ODS Hypersil column and a solvent including distilled water and methanol wherein the solvent was supplied at a flow rate of 1.0 ml/min with application of a linear gradient from 15% to 70% methanol over 15 minutes. As a result of analysis, the presence of the compounds of Formulae 1 to 12 was confirmed. Chemical constitutional compositions of the compositions 1 to 5 are shown in Table 1 below.

TABLE 1

| Sample | Constitutional composition of sample |
|---|---|
| Composition | 20 wt. % of total phlorotannin including 2 wt. % of |
| 1 | Formula 2, 1 wt. % of Formula 4, 0.5 wt. % of Formula |
| | 5, 0.3 wt. % of Formula 8, 8.2 wt. % of other single |
| | substances of Formulae 1 to 12, and 8 wt. % of |
| | phlorotannin complex other than Formulae 1 to 12; |
| | 25 wt. % of mannitol; 20 wt. % of alginic acid; |
| | 20 wt. % of fucoidan; 5 wt. % of fucosterol; |
| | 5 wt. % of fucoxanthin; and 5 wt. % of laminarin |
| Composition | 70 wt. % of total phlorotannin including 10 wt. % of |
| 2 | Formula 2, 3 wt. % of Formula 4, 1 wt. % of Formula |
| | 5, 1.5 wt. % of Formula 8, 24.5 wt. % of other single |
| | substances of Formulae 1 to 12, and 30 wt. % of |
| | phlorotannin complex other than Formulae 1 to 12; |
| | 10 wt. % of mannitol; 6 wt. % of alginic acid; |
| | 6 wt. % of fucoidan; 3 wt. % of fucosterol; |
| | 3 wt. % of fucoxanthin; and 2 wt. % of laminarin |
| Composition | 100 wt. % of total phlorotannin including 17 wt. % of |
| 3 | Formula 2, 5 wt. % of Formula 4, 5 wt. % of Formula 5, |
| | 3 wt. % of Formula 8 and 70 wt. % of other single |
| | substances of Formulae 1 to 12 |
| Composition | 100 wt. % of total phlorotannin including 50 wt. % of |
| 4 | Formula 5, 46 wt. % of Formula 8, and 4 wt. % of other |
| | single substances of Formulae 1 to 12 |
| Composition | 100 wt. % of total phlorotannin including 63 wt. % of |
| 5 | Formula 5, 34 wt. % of Formula 8, and 3 wt. % of other |
| | single substances of Formulae 1 to 12 |

### Example 2—Flavor Improvement Effects on Cooked Rice Using the Composition

After washing 4,200 g of uncooked rice, 700 g of washed ricewas placed in each of six (6) rice cookers without soaking. Further, after adding 1,400 cc of water thereto, 140 mg of each of compositions 1, 2, 3, 4, and 5 was placed in each rice cooker. Thereafter, the rice in water was stirred 5 times. On the other hand, nothing was added to the one remaining rice cooker. The rice cookers were turned on to cook the rice. After cooking, water contents were measured after leaving the cooked rice at room temperature for 2, 4, 6 and 12 hours, respectively. Further, the rice chilled for 30 minutes after cooking was frozen in a freezer at −20° C. for 24 hours, and then thawed at room temperature for 6 hours to measure the water content. The water content was measured with a heating typewater content meter and the heating temperature was 120° C. Results of water content (wt. %) of rice when left at room temperature are summarized in Table 2. Compared to the rice without addition of the composition, the rice with addition of the composition has higher water retention, whereby rice taste was better maintained even when left for a long time.

TABLE 2

| Composition added | | No addition | | | | | |
|---|---|---|---|---|---|---|---|
| during rice | | of | Composition | Composition | Composition | Composition | Composition |
| cooking | | composition | 1 | 2 | 3 | 4 | 5 |
| Leaving | 2 | 58 | 58 | 60 | 63 | 65 | 63 |
| time | 4 | 50 | 56 | 58 | 63 | 61 | 63 |
| | 6 | 44 | 52 | 58 | 58 | 60 | 62 |
| | 12 | 31 | 42 | 55 | 55 | 59 | 58 |

| | | | | | | |
|---|---|---|---|---|---|---|
| Rice thawed after | 60 | 61 | 62 | 65 | 66 | 66 |
| freezing for 24 | | | | | | |
| hours | | | | | | |

Further, ten (10) tasting evaluators were asked to evaluate the rice 15 minutes after cooking. As a result of a specific questionnaire about improvement points for the case where the improvement points were recognized, it was suggested that improvements have been achieved as shown in Table 3 below.

TABLE 3

| Flavor | |
|---|---|
| elements | Specific improvements in individual elements |
| Chewing | Favorable elasticity when chewing. Soft and smooth mouth |
| taste | feel when touching the tongue |
| Physical | Smooth shape and clear outline of cooked rice grain. More |
| properties | glossy rice |
| Flavor | No stale smell commonly and faintly felt in cooked rice. |
| | Better flavor of rice |

In order to confirm whether the preservation of rice was improved, the rice was cooked under the same conditions as in water content confirmation, chilled completely, packed in a small container of 200 g, and then refrigerated. In order to confirm the preservation, rice stored in the refrigerator for 1 week was heated in a microwave oven, and then 10 evaluators evaluated improvement. Detailed evaluation contents, that is, improvement points of the preservation of rice containing the composition are summarized in Table 4 below.

TABLE 4

| Flavor | |
|---|---|
| elements | Specific improvements in individual elements |
| Physical | Shape of cooked rice grain better remained. More glossy |
| properties | rice. The cooked rice grain looked better and moist. Not |
| | yellowish but bright color of rice grain |
| Flavor | Compared to no addition of composition, stale smell is |
| | reduced. Flavor of uncooked rice is better sensed. |

### Example 3—Preparation of Liquid Product Using the Composition as Active Ingredient

Preparative examples including the composition as an active ingredient were prepared in the following weight ratio as shown in Table 5 below. Further, comparative examples for comparative experiments were prepared as shown in Table 5 below.

TABLE 5

| | | | Preparative Example | | | | |
|---|---|---|---|---|---|---|---|
| | | | Preparative | Preparative | Preparative | Preparative | Preparative |
| Raw material to | | Comparative | Example | Example | Example | example | Example |
| be mixed | | Example | 1 | 2 | 3 | 4 | 5 |
| Ingredients | Ingredients | — | Composition | Composition | Composition | Composition | Composition |
| contained | | | 1 | 2 | 3 | 4 | 5 |
| | Content | | 0.2 | 0.2 | 0.2 | 0.2 | 0.2 |

| | | | | | | |
|---|---|---|---|---|---|---|
| Purified water | 100 | 99.8 | 99.8 | 99.8 | 99.8 | 99.8 |

### Example 4—Flavor Improvement Effects on Roasted Beef Using the Products of the Preparative Examples

After dividing 1,200 g of beef sirloin cut at the same site by 200 g each, and evenly spraying 3 mL of each of products in Preparation Examples 1 to 5 of Comparative Example and Example 3, each was left at room temperature for 15 minutes. After putting the cut meats in six (6) 10-inch frying pans, respectively, and cooking the same at the same intensity, 10 evaluation panels were asked to evaluate the meat cooked in each frying pan. Each cooked meat sample was evaluated in three separate aspects: chew, appearance and flavor, followed by voting on the best meat overall (multiple votes possible). These tests were conducted three times, and the evaluation results for roast beef cooked along with the composition are summarized in Table 6 below. As a result, the number of votes was much higher when the products of the preparative examples were added compared to the case with no addition thereof.

TABLE 6

| | Composition added when cooking beef | | | | | |
|---|---|---|---|---|---|---|
| | | Addition | Addition | Addition | Addition | Addition |
| | | of | of | of | of | of |
| | | product of | product of | product of | product of | product of |
| | | Preparative | Preparative | Preparative | Preparative | Preparative |
| | Comparative | Example | Example | Example | Example | Example |
| | Example | 1 | 2 | 3 | 4 | 5 |
| Number | 1 | 5 | 8 | 10 | 10 | 9 |
| of votes | | | | | | |
| on | | | | | | |
| overall | | | | | | |
| good | | | | | | |
| beef | | | | | | |

As a result of completing a specific questionnaire about improvement points in the cases where the improvement points were felt, it was suggested that improvements are demonstrated as shown in Table 7 below.

TABLE 7

| Flavor elements | Specific improvements for individual elements |
|---|---|
| Chewing taste | Soft and juicy |
| Physical | Meat texture looks a little more elastic and fewer |
| property | burnt areas are included |
| Scent | Savory taste is more intense. Meat is tastier with |
| | good flavor and less offensive odor. |

### Example 5—Tofu Manufacturing Process and Flavor Improvement Effects Using Products of Preparative Examples

In order to confirm effects of improving the flavor of tofu using the products of the preparative examples and the comparative example, 9 kg of beans was washed with sufficient water. After dividing the washed beans into six (6) equal parts, 6 kg of room temperature water as well as mL of each product of the comparative examples and Preparative Examples 1 to 5, respectively, were added and soaked for 5 hours (5 hours in summer and 15 hours in winter). When soaking was completed, the beans in water were ground in a grinder for 1.5 minutes and filtered through a 100 mesh sieve to separate soybean flour and soy milk. To the soymilk to which the product of each comparative example was added, 20 mL of antifoaming agent was added, while the soymilk to which the product of each preparative example was added omitted addition of the antifoaming agent, followed by heating each soymilk sample at 93° C. for about 10 minutes to reach 8 to 9 brix. In addition, 4 mL of the product of each of the comparative example and preparative examples was sprayed on to each soymilk sample. In the comparative example, 37.5 g of brine and 22.5 g of salt were added. On the other hand, in each of the preparative examples, 37.5 g of brine and 10.8 g of salt were added to solidify the soymilk for about 20 to 25 minutes. When solidification was completed, the product was put into a mold and chilled to complete tofu production. In the case of the preparative example, even when no antifoaming agent was added, foaming did not occur during heating. Further, even when an amount of the salt added for coagulation was slightly decreased, physical properties were not significantly different compared to the preparative examples.

Ten (10) evaluators were asked to taste the completely manufactured tofu and evaluate the same in three aspects of physical properties, texture and flavor, followed by voting on the best tofu in overall aspects. The voting results are shown in Table 8 below, while improvements felt by the evaluators are also shown in Table 9 below.

TABLE 8

| | Composition added when making tofu | | | | | |
|---|---|---|---|---|---|---|
| | | Addition | Addition | Addition | Addition | Addition |
| | | of | of | of | of | of |
| | | product of | product of | product of | product of | product of |
| | | Preparative | Preparative | Preparative | Preparative | Preparative |
| | Comparative | Example | Example | Example | Example | Example |
| | Example | 1 | 2 | 3 | 4 | 5 |
| Number | 0 | 5 | 10 | 9 | 10 | 10 |
| of votes | | | | | | |
| forbest | | | | | | |
| tofu | | | | | | |

TABLE 9

| Flavor | |
|---|---|
| elements | Specific improvement for individual elements |
| Texture | Elastic but soft texture |
| Physical | Smooth surface of tofu, and small tofu particles |
| properties | |
| Flavor | Savory scent of soybeans is well felt with less soybean |
| | grass smell |

When adding the product of each preparative example, the texture, mouth feel and scent of tofu were improved, and natural taste of the tofu was realized by adding a small amount of salt.

### Example 6—Flavor Improvement Effects on Coffee, Tea and Beverages Using the Products of the Preparative Examples

In order to confirm effects of improving the flavor of coffee, tea and beverages using the product of each preparative example, the products of the preparative examples and the comparative example were added to commercially available bottled water, coffee, tea, fruit beverages and carbonated beverages, followed by comparison. More particularly, after adding 0.3 mL of each of the products of the preparative examples and the comparative example to 300 mL of coffee, green tea, orange juice and cola, flavor improving effects were evaluated by 10 evaluators for each of the beverages. Improvements for beverages are shown in Table 10 below.

TABLE 10

| Type of | |
|---|---|
| beverage | Improvement of beverage |
| Bottled water | Water tastebecomes soft. |
| Coffee | Rich aroma, softer taste and better acidity of coffee. |
| Green tea | More savory taste and strong green tea scent |
| Orange juice | Harmony of sweet and sour tastes. Thicker orange |
| | flavor and clean taste of orange juice. |
| Cola | Strong and long lasting carbonation. Cleanaftertaste. |

### Example 7—Flavor Improvement Effects on Alcoholic Beverages Using the Products of the Preparative Examples

In order to confirm effects of improving the flavor of liquors using the products of the preparative examples, the products of the preparative examples and the comparative example were added to commercially available red wine, white wine, soju, beer and whiskey, followed by comparison. More particularly, after adding 0.3 mL of each of the products of the preparative examples and the comparative example to 300 mL of each alcoholic beverage, flavor and hangover improving effects were evaluated by 10 evaluators for each of the beverages. Improvements for alcoholic beverages are shown in Table 11 below. As a result of summarizing the improvement points, it could be seen that softer taste and stronger flavor were commonly sensed regardless of the types of alcoholic beverages. Further, there was an advantage of reduced hangover.

TABLE 11

| Types | Specific improvements for individual elements |
|---|---|
| Red wine | Taste becomes softer, tannin taste is clearly felt, |
| | richness and smooth throat feel are greatly improved. |
| | Unique flavor of the wine becomes stronger. Hangover |
| | lessens the next day. |
| White wine | Sweetness and acidity feel harmonious, scent of grapes |
| | feels strong, and burden or trouble in drinking is |
| | reduced. |
| Soju | Peculiar smell of alcohol disappears, bitterness is |
| | reduced, and hangover lessens the next day |
| Beer | Scent becomes stronger with better clean and refreshed |
| | feelings due to carbonation. Clean aftertaste |
| Whiskey | Rich aroma of aged whiskey. Soft taste and smooth throat |
| | feeling. No hangover appears the next day |

### Example 8—Flavor Improvement Effects on Noodles Using the Products of the Preparative Examples

In order to confirm effects of improving the flavor of noodles using the products of the preparative examples, the products of the preparative examples and the comparative example were added to commercially available ramen products, followed by comparison. More particularly, in each case, one serving of ramen (120 g) was cooked using 450 mL of drinking water. During cooking, 1 mL of each of the products of the preparative examples and the comparative example was added to the ramen. In the case of the ramen to which the product of each preparative example was added, only 70 wt. % of the seasoning normally provided in the ramen product was added. On the other hand, in the comparative example, the ramen was cooked with 100 wt. % of the provided seasoning. 10 evaluators were asked to evaluate flavor improvement effects based on taste and elasticity of the noodles, followed by multiple voting on the best ramen in overall aspects. The voting results are shown in Table 12 below, improvements of the ramen with addition of the product of each preparative example, as compared to the comparative example, are shown in Table 13 below.

TABLE 12

| | Composition added when cooking ramen | | | | | |
|---|---|---|---|---|---|---|
| | | Addition | Addition | Addition | Addition | Addition |
| | | of | of | of | of | of |
| | | product of | product of | product of | product of | product of |
| | | Preparative | Preparative | Preparative | Preparative | Preparative |
| | Comparative | Example | Example | Example | Example | Example |
| | example | 1 | 2 | 3 | 4 | 5 |
| Number | 2 | 4 | 8 | 9 | 8 | 10 |
| of votes | | | | | | |
| on the | | | | | | |
| best | | | | | | |
| ramen | | | | | | |

TABLE 13

| Flavor | |
|---|---|
| elements | Specific improvements for individual elements |
| Taste | Less irritating tastes such as salty and spicy. Good |
| | taste balance. Suitably salty without feeling weak |
| | (bland) even by adding less seasoning. Less unique |
| | smell of the noodle. |
| Elasticity | Elasticity of the noodle is maintained throughout |
| | eating, and the noodle surface looks smooth |

When cooking ramen, intake of plenty of salt contained in the ramen seasoning may be reduced by adding the composition of the present invention, as well as improving the texture of the noodle without being swollen during meals.

Example 9—Flavor Improvement Effects on Food Using the Products of the Preparative Examples

Each of the products of Preparative Example 3 and the comparative example was used in manufacturing a spray container which dispenses 0.3 mL of the product per spray. After providing the manufactured containers to 10 evaluators, flavor improvement effects were confirmed by spraying the product of each of the preparative examples and the comparative example on ceon the food cooked at home. The product was applied to seafood, beef bone soup, vegetables, etc., and improvement points felt by the evaluators are shown in Table 14 below.

TABLE 14

| Type | Specific improvements for individual elements |
|---|---|
| Seafood | Fishy smell is reduced. During cooking, moisture escaping |
| | from seafood is reduced. Elasticity of seafood is |
| | maintained for a long time. |
| Beef bone | Less bland (weak) taste even by adding less salt. The |
| soup | broth has less meat smell but increased savory taste. |
| Seasoned | Moisture escaping from vegetable during cooking is |
| vegetables, | reduced. In the case of bean sprouts and green-bean |
| stir-fried | sprouts, grass smell decreases. Retainsoriginal taste and |
| vegetables | scent of ingredients stronger. |

### INDUSTRIAL APPLICABILITY

The composition and product of the present invention are used when cooking food materials containing carbohydrates and proteins as main ingredients, when manufacturing processed foods such as ramen, when preparing vegetable protein foods such as tofu, or when drinking alcoholic beverages, coffee, tea, beverages, etc., whereby elasticity, texture or taste of the prepared or cooked foods are increased, thereby improving flavor thereof.

1. A composition for food flavor improvement, comprising phlorotannin as an active ingredient.

2. The composition according to claim 1, wherein the phlorotannin is one or more selected from phlorotannins represented by each of Formulae 1 to 12 below:

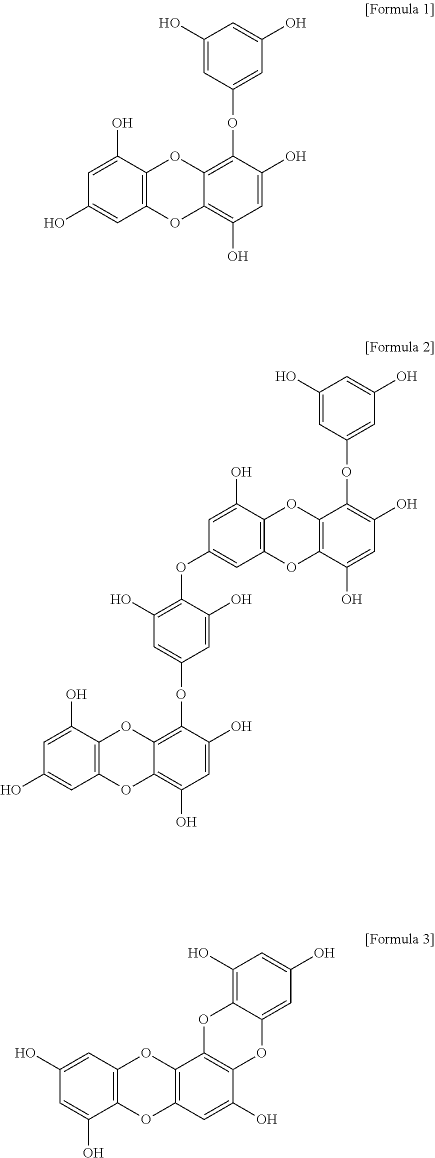 [SMILES: Oc1cc(O)cc(Oc2c(O)cc(O)c3c2Oc2c(O)cc(O)cc2O3)c1 ; Oc1cc(O)cc(Oc2c(O)cc(O)c3c2Oc2c(O)cc(Oc4c(O)cc(Oc5c(O)cc(O)c6c5Oc5c(O)cc(O)cc5O6)cc4O)cc2O3)c1 ; Oc1cc(O)c2oc3cc(O)c4oc5cc(O)cc(O)c5oc4c3oc2c1]

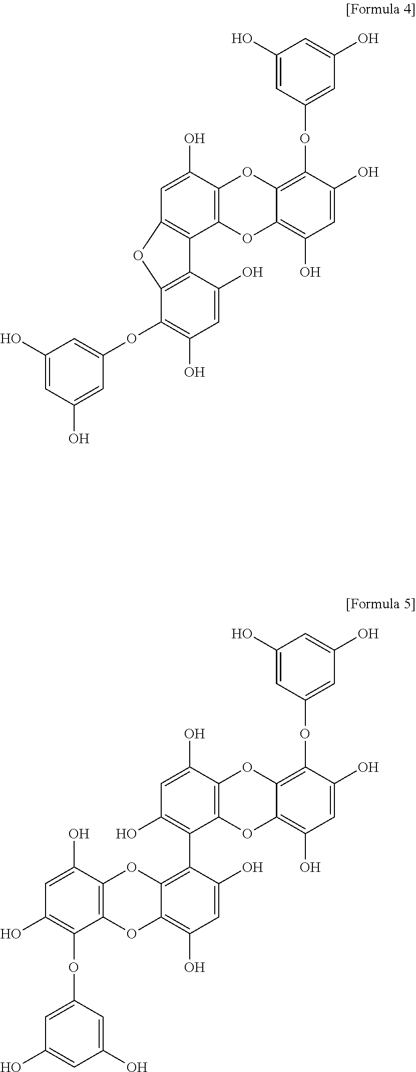 [SMILES: Oc1cc(O)cc(Oc2c(O)cc(O)c3c2Oc2c(O)cc4oc5c(Oc6cc(O)cc(O)c6)c(O)cc(O)c5c4c2O3)c1 ; Oc1cc(O)cc(Oc2c(O)cc(O)c3c2Oc2c(O)cc(O)c(-c4c(O)cc(O)c5c4Oc4c(O)cc(O)c(Oc6cc(O)cc(O)c6)c4O5)c2O3)c1]

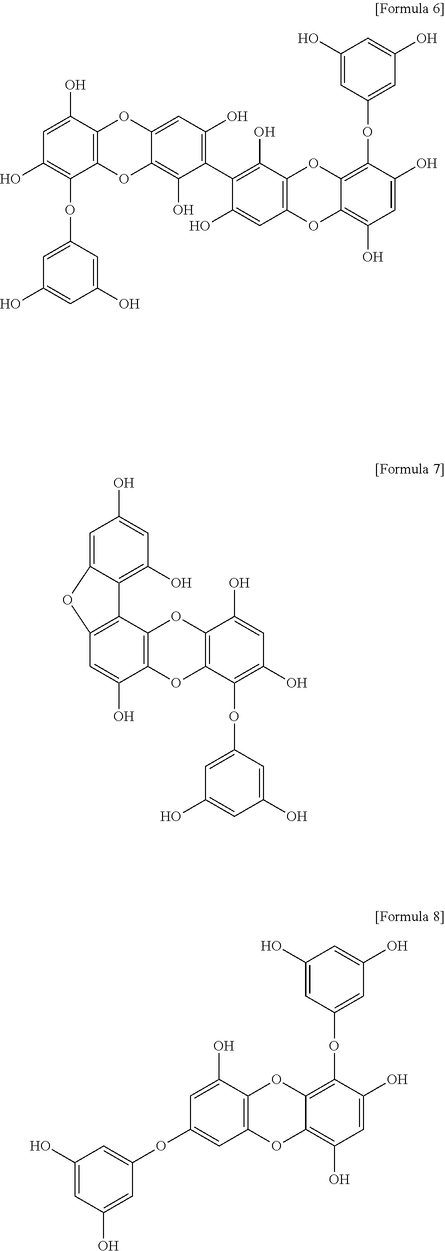 [SMILES: Oc1cc(O)cc(Oc2c(O)cc(O)c3c2Oc2c(cc(O)c(-c4c(O)cc5c(c4O)Oc4c(Oc6cc(O)cc(O)c6)c(O)cc(O)c4O5)c2O)O3)c1 ; Oc1cc(O)cc(Oc2c(O)cc(O)c3c2Oc2c(O)cc4oc5cc(O)cc(O)c5c4c2O3)c1 ; Oc1cc(O)cc(Oc2cc(O)c3c(c2)Oc2c(O)cc(O)c(Oc4cc(O)cc(O)c4)c2O3)c1]

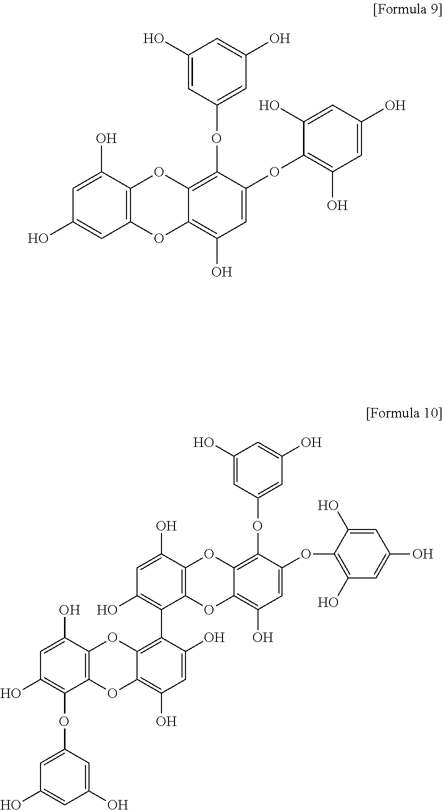 [SMILES: Oc1cc(O)cc(Oc2c(Oc3c(O)cc(O)cc3O)cc(O)c3c2Oc2c(O)cc(O)cc2O3)c1 ; Oc1cc(O)cc(Oc2c(O)cc(O)c3c2Oc2c(O)cc(O)c(-c4c(O)cc(O)c5c4Oc4c(O)cc(Oc6c(O)cc(O)cc6O)c(Oc6cc(O)cc(O)c6)c4O5)c2O3)c1]

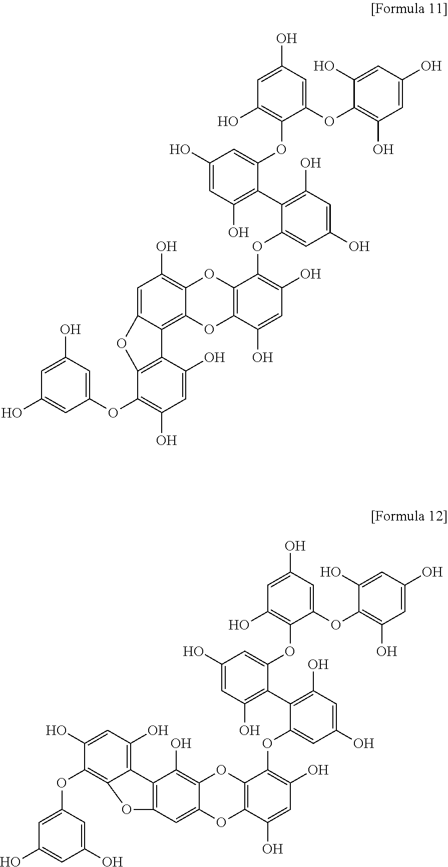 [SMILES: Oc1cc(O)cc(Oc2c(O)cc(O)c3c2oc2cc(O)c4c(c23)Oc2c(O)cc(O)c(Oc3cc(O)cc(O)c3-c3c(O)cc(O)cc3Oc3c(O)cc(O)cc3Oc3c(O)cc(O)cc3O)c2O4)c1 ; Oc1cc(O)cc(Oc2c(O)cc(O)c3c2oc2cc4c(c(O)c23)Oc2c(c(O)cc(O)c2Oc2cc(O)cc(O)c2-c2c(O)cc(O)cc2Oc2c(O)cc(O)cc2Oc2c(O)cc(O)cc2O)O4)c1]

3. The composition according to claim 1, wherein the composition includes 20 to 100% by weight (“wt. %”) of phlorotannin to a total weight of the composition.

4. The composition according to claim 2, wherein the composition includes one or more phlorotannins selected from phlorotannin of Formula 2, phlorotannin of Formula 4, phlorotannin of Formula 5 and phlorotannin of Formula 8.

5. The composition according to claim 4, wherein the composition includes: 1 to 60 wt. % of phlorotannin of Formula 2; 0.3 to 20 wt. % of phlorotannin of Formula 4; 0.1 to 10 wt. % of phlorotannin of Formula 5; and 0.1 to 5 wt. % of phlorotannin of Formula 8.

6. The composition according to claim 4, wherein the composition includes: 1 to 65 wt. % of phlorotannin of Formula 2; and 0.3 to 45 wt. % of phlorotannin of Formula 4.

7. The composition according to claim 4, wherein the composition includes: 1 to 45 wt. % of phlorotannin of Formula 5; and 0.3 to 45 wt. % of phlorotannin of Formula 8.

8. The composition according to claim 4, wherein the composition includes: 0.1 to 3 wt. % of phlorotannin of Formula 1; 5 to 63 wt. % of phlorotannin of Formula 2; 1 to 3 wt. % of phlorotannin of Formula 3; 0.5 to 34 wt. % of phlorotannin of Formula 4; 0.1 to 50 wt. % of phlorotannin of Formula 5; 0.5 to 8 wt. % of phlorotannin of Formula 6; 0.1 to 1 wt. % of phlorotannin of Formula 7; 0.1 to 46 wt. % of phlorotannin of Formula 8; 0.1 to 2 wt. % of phlorotannin of Formula 9; 0.1 to 7 wt. % of phlorotannin of Formula 10, 0.1 to 3 wt. % of phlorotannin of Formula 11; and 0.1 to 4 wt. % of phlorotannin of Formula 12.

9. The composition according to claim 3, wherein the composition includes 20 to 100 wt. % of phlorotannin, 0 to 30 wt. % of mannitol, 0 to 25 wt. % of alginic acid, 0 to 25 wt. % of fucoidan, 0 to 10 wt. % of fucosterol, 0 to 10 wt. % of fucoxanthin and 0 to 10 wt. % of laminarin.

10. The composition according to claim 3, wherein the composition includes 20 to 97 wt. % of phlorotannin, 1 to 30 wt. % of mannitol, 1 to 25 wt. % of alginic acid, 0.5 to 25 wt. % of fucoidan, 0.1 to 10 wt. % of fucosterol, 0.1 to 10 wt. % of fucoxanthin and 0.1 to 10 wt. % of laminarin.

11. The composition according claim 1, wherein the composition for improvement of food flavor, which contains phlorotannin as an active ingredient, is an extract extracted from one or more selected from the group consisting of Eisenia bicyclis, Ecklonia nurome, Ecklonia cava, Ecklonia stolonifera, Ecklonia maxima and Ecklonia radiate.

12. The composition according to claim 1, wherein the composition is used when cooking carbohydrate-containing food, when cooking protein-containing food, in a tofu manufacturing process, or when drinking a liquid food.

13. A food flavor improving product including the composition for improvement of food flavor according to claim 1.

14. The product according to claim 13, wherein the product includes 0.1 to 100 wt. % of a phlorotannin composition.

15. The product according to claim 13, wherein the product includes 0.2 to 50 wt. % of a phlorotannin composition, 0 to 99.8 wt. % of polymer derived from carbohydrates useable in food production, and 50 to 99.8 wt. % of purified water.

16. The product according to claim 15, wherein the polymer is one or more selected from the group consisting of dextrin, maltodextrin, pectin, xanthangum, cellulose and dietary fiber.

17. The product according to claim 13, wherein the product is used when cooking carbohydrate-containing food, when cooking protein-containing food, in a tofu manufacturing process, or when drinking a liquid product.
